(19) United States
(12) Patent Application Publication
(10) Pub. No.: US 2026/0280003 A1
(43) Pub. Date: Sep. 17, 2026

(54) Battery Pack Housing, a Battery Pack, and an Electric Tool

(71) Applicants: Bosch Power Tools (China) Co., Ltd., Hangzhou (CN); Robert Bosch GmbH, Stuttgart (DE)

(72) Inventor: Aigui Wang, Hangzhou (CN)

(21) Appl. No.: 19/561,117

(22) Filed: Mar. 9, 2026

(30) Foreign Application Priority Data
Mar. 12, 2025 (CN) 2025 2043 1856.8

(51) Int. Cl. H01M 50/242; H01M 50/213; H01M 50/247

(52) U.S. Cl. CPC H01M 50/242; H01M 50/213; H01M 50/247; H01M 2220/30

(57) ABSTRACT

A battery pack housing with a cell accommodating chamber inside is disclosed. At least one wall structure is provided between the outer wall of the cell accommodating chamber and the battery pack housing. The wall structure, the battery pack housing, and the outer wall of the cell accommodating chamber form a number of closed cavities. When the battery pack housing is subjected to an impact force, the cavities can deform to absorb the impact force. This battery pack housing can absorb the kinetic energy of the impact when the battery pack is bumped or impacted, thereby better protecting the battery cells and reducing the safety risks caused by deformation of the battery cells.

This application claims priority under 35 U.S.C. § 119 to application no. CN 2025 2043 1856.8, filed on Mar. 12, 2025 in China, the disclosure of which is incorporated herein by reference in its entirety.

The disclosure relates to a housing structure, and particularly to a housing structure for a battery pack.

### BACKGROUND

For electric tools using battery packs, the potential safety risks need to be considered. For example, electric tools may be used for high-altitude operations, and if they are accidentally dropped from a height, this will cause a great impact on the battery pack. At this time, the battery cells will be compressed, causing a risk of explosion and fire.

Therefore, in order to better protect the battery pack, protective measures need to be provided for the battery pack. One current approach is to design the overall layout of the electric tool itself so that the battery pack is located in a position that will not be impacted if the tool is dropped. However, this setup is limited by the design of the electric tool itself, with limited room for design adjustments and poor adaptability.

In addition, other methods include wrapping the battery pack with a buffer layer or adding a protective barrier. However, this setup requires adding additional elements outside the battery pack, increasing the complexity of the battery pack structure. Furthermore, the external buffer layer or protective barrier is prone to damage during battery pack use.

### SUMMARY

One of the purposes of the present disclosure is to provide a battery pack housing that can absorb the kinetic energy of the impact when the battery pack is bumped or impacted, thereby better protecting the battery cells and reducing the safety risks caused by deformation of the battery cells.

In order to achieve the above purpose, the present disclosure proposes a battery pack housing with a cell accommodating chamber inside. At least one wall structure is provided between the outer wall of the cell accommodating chamber and the battery pack housing. The wall structure, the battery pack housing, and the outer wall of the cell accommodating chamber form a number of closed cavities. When the battery pack housing is subjected to an impact force, the cavities deform to absorb the impact force, thereby acting as a buffer.

Further, the battery pack housing of the present disclosure comprises a first housing and a second housing arranged separately and connected together, the cell accommodating chamber being disposed on the second housing, and the first housing and the second housing being connected together with the wall structure and the outer wall of the cell accommodating chamber to form the closed cavities.

Further, in the battery pack housing of the present disclosure, the Young's modulus of the second housing is less than the Young's modulus of the first housing.

Further, in the battery pack housing of the present disclosure, the difference between the Young's modulus of the second housing and the Young's modulus of the first housing is 600-3500 MPa.

Further, in the battery pack housing of the present disclosure, the inner side of the first housing is provided with a rib protruding from the surface, and the second housing is provided with a slot, the end of the rib being inserted correspondingly into the slot.

Further, in the battery pack housing of the present disclosure, the rib is disposed at the axial end face of the cell accommodating chamber.

Further, in the battery pack housing of the present disclosure, at least one of the cavities is disposed so as to extend through at least one full-size direction of the battery pack housing.

Further, in the battery pack housing of the present disclosure, at least one cavity is disposed at a corner of the battery pack housing.

Further, in the battery pack housing of the present disclosure, at least one cavity extends along the axial direction of the cell accommodating chamber and is disposed below the cell accommodating chamber.

Further, in the battery pack housing of the present disclosure, at least one of the cavities is provided with a buffer element.

Further, in the battery pack housing of the present disclosure, the buffer element is disposed at least within a cavity at a corner of the battery pack housing.

Further, in the battery pack housing of the present disclosure, the buffer element comprises an elastomeric filler and/or a spring plate.

Another purpose of the present disclosure is to provide a battery pack with high safety performance.

For the above purposes, the present disclosure further provides a battery pack comprising a battery pack housing as described above, wherein a battery cell is disposed within the cell accommodating chamber of the battery pack housing.

In addition, another purpose of the present disclosure is to provide an electric tool with high safety and a good user experience.

For the above purposes, the present disclosure further provides an electric tool equipped with a battery pack as described above.

Through the structural design of the housing itself, the battery pack housing of the present disclosure can effectively absorb the impact force of collisions, thereby protecting the safety of the battery cells. In addition, the battery pack housing has a simple and compact structure and low cost.

### BRIEF DESCRIPTION OF THE DRAWINGS

FIG. 1 schematically shows the external structure of the battery pack housing of the present disclosure in one embodiment.

FIG. 2 shows the internal structure of the battery pack housing of the present disclosure in one embodiment.

FIG. 3 shows the first housing of the battery pack housing of the present disclosure in one embodiment.

FIG. 4 schematically shows the impact force received by the battery pack housing of the present disclosure in one embodiment.

FIG. 5 shows the slot of the battery pack housing of the present disclosure in one embodiment.

FIG. 6 shows the cavity of the battery pack housing of the present disclosure in one embodiment from a frontal view.

FIG. 7 shows the cavity placement of the battery pack housing of the present disclosure in one embodiment.

FIG. 8 shows the buffer element of the battery pack housing of the present disclosure in one embodiment.

### DETAILED DESCRIPTION

The battery pack housing, battery pack, and electric tool of the present disclosure will be further explained and described below with reference to the accompanying drawings and specific examples. However, this explanation and description do not constitute an undue limitation on the technical solution of the present disclosure.

For electric tools using battery packs, the potential safety risks need to be considered. For example, when the battery pack is bumped or impacted, the battery cells will be compressed, causing a risk of explosion and fire. Therefore, in order to better protect the battery pack, protective measures need to be provided for the battery pack.

One current solution is to design the overall layout of the electric tool itself so that the battery pack is located in a position that will not be impacted if the tool is dropped. However, this setup is limited by the design of the electric tool itself, with limited room for design adjustments and poor adaptability.

In addition, other solutions include wrapping the battery pack with a buffer layer or adding a protective barrier. However, this setup requires adding additional elements outside the battery pack, increasing the complexity of the battery pack structure. Furthermore, the external buffer layer or protective barrier is prone to damage during battery pack use.

To address this issue, the present disclosure provides, in one embodiment, a battery pack housing that can provide effective protection for the battery cells with a simple structural design.

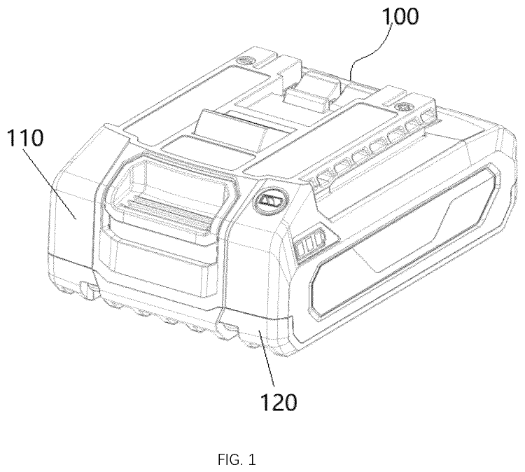

FIG. 1 schematically shows the external structure of the battery pack housing of the present disclosure in one embodiment.

As shown in FIG. 1, in some embodiments, the battery pack housing 100 is configured as a protective housing wrapped around the periphery of the battery cells.

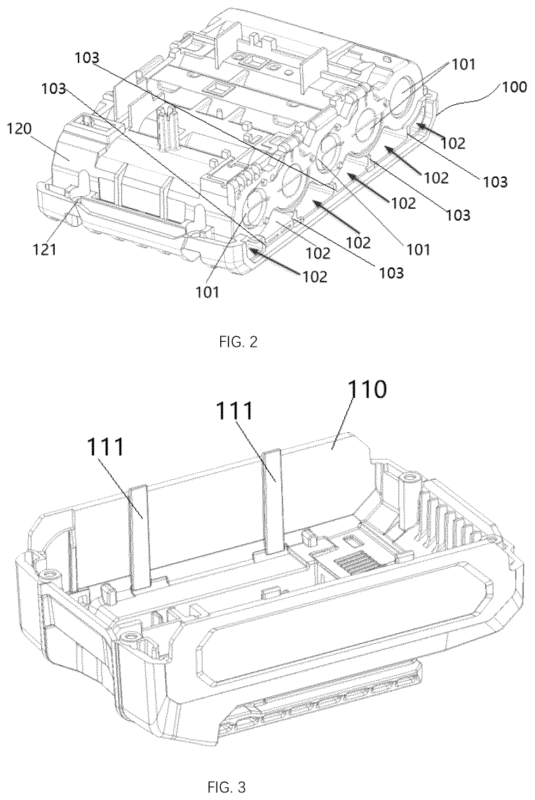

FIG. 2 shows the internal structure of the battery pack housing of the present disclosure in one embodiment.

As shown in FIG. 2, in some embodiments, the interior of the battery pack housing has a number of cell accommodating chambers 101 for accommodating battery cells. In addition, at least one wall structure 103 is provided between the outer wall of the cell accommodating chamber 101 and the battery pack housing, and the wall structure 103 together with the battery pack housing 100 and the outer wall of the cell accommodating chamber 101 form a number of closed cavities 102. When the battery pack housing is subjected to an impact force, the cavities 102 can deform to absorb the impact force, thereby acting as a buffer.

It should be noted that in FIG. 2, in order to clearly show the cavities, a portion of the housing has been removed; when the removed portion of the housing is mounted to the housing shown in FIG. 2, closed cavities are formed.

For example, in some specific embodiments, for ease of installation, the battery pack housing may comprise a first housing 110 (e.g., as shown in FIG. 3) and a second housing 120, which are provided separately and connected together. In some more specific embodiments, the first housing and the second housing may be connected by bolts disposed within screw holes 121.

The cell accommodating chamber 101 is disposed on the second housing 120, and when the first housing 110 and the second housing 120 are assembled together, a number of closed cavities 102 are formed. These closed cavities form a buffer structure similar to an airbag.

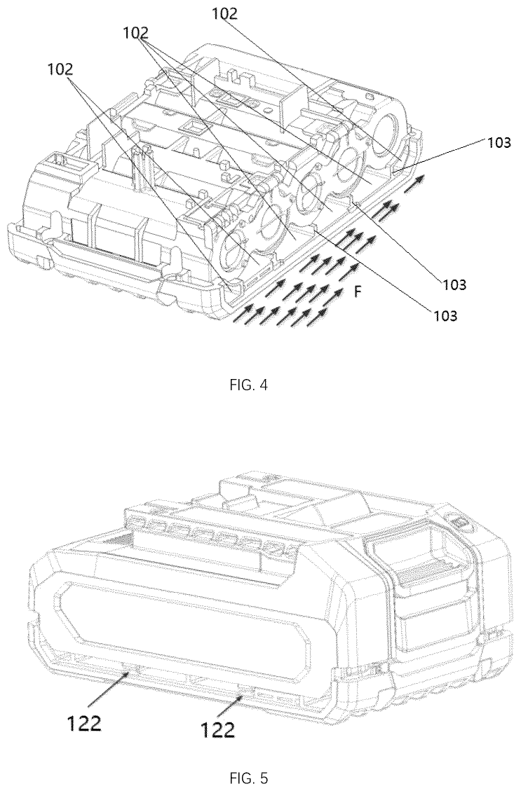

As shown in FIG. 4, when the battery pack housing is subjected to an impact force, a number of cavities 102 deform and gradually absorb and transfer the impact force F, thereby achieving better protection of the battery pack.

It is to be noted that although FIG. 2 schematically shows six cavities, the present disclosure may also provide other numbers of a plurality of cavities.

In some more specific embodiments, the first housing 110 and the second housing 120 are made of different materials, and the Young's modulus of the second housing 120 is less than the Young's modulus of the first housing 110; that is, the second housing is softer than the first housing. With this configuration, when the battery pack is impacted, the second housing 120 is relatively soft, and its superimposed cavities first absorb the impact force; after the cavities are fully deformed, the impact force is transferred to the first housing 110. Because the first housing is relatively hard, it can provide strong support and prevent further deformation of the second housing. Thus, the first housing 110 and the second housing 120 work together to better protect the battery cells.

In some more specific embodiments, the difference between the Young's modulus of the second housing 120 and the Young's modulus of the first housing 110 may be 600-3500 MPa.

In one more specific example, the second housing may be made of PC-ABS (polycarbonate-acrylonitrile-butadiene-styrene copolymer) with a Young's modulus of 2000 MPa-2800 MPa and the first housing may be made of PA (polyamide) with a Young's modulus of 3000 MPa-5000 MPa.

As shown in FIG. 3, in some more specific embodiments, the inner side of the first housing 110 is provided with a rib 111 protruding from the surface. Accordingly, as shown in FIG. 5, the second housing is provided with a slot 122, and the end of the rib 111 is inserted correspondingly into the slot 122. This structure can achieve interlocking after the assembly of the first housing and the second housing, serving a positioning function. In addition, the rib also acts as a reinforcing rib, thereby preventing deformation of the first housing when the battery pack is impacted.

In some more specific embodiments, after the first housing and the second housing are assembled, the rib 111 is located at the axial end face of the cell accommodating chamber. In this way, the rib can also serve to fix the battery cell, preventing the cell from undergoing axial displacement when the battery pack is dropped and thereby preventing unpredictable failures.

It is to be noted that the number of ribs and slots in FIGS. 3 and 5 being two pairs is merely exemplary. In other embodiments, ribs may also be provided at the axial end face of each of the cell accommodating chambers, and corresponding slots may be provided on the second housing.

In some more specific embodiments, at least one cavity 102 may be disposed so as to extend through at least one full-size direction of the battery pack housing.

For example, as shown in FIG. 2, a number of cavities 102 are arranged along the length of the battery pack housing, with a single cavity 102 extending fully through the entire width of the battery pack housing.

For example, the cavity may also be disposed to extend through the length of the battery pack housing, or to extend through the height of the battery pack housing. This through-hole arrangement is intended to facilitate the manufacturing and processing of cavities.

Conversely, in some other embodiments, the cavity may also be disposed in some direction discontinuously or in a non-through manner. For example, along the length of the battery pack housing, a cavity with an extension size much smaller than the battery pack housing is provided, or there are a number of independent cavities.

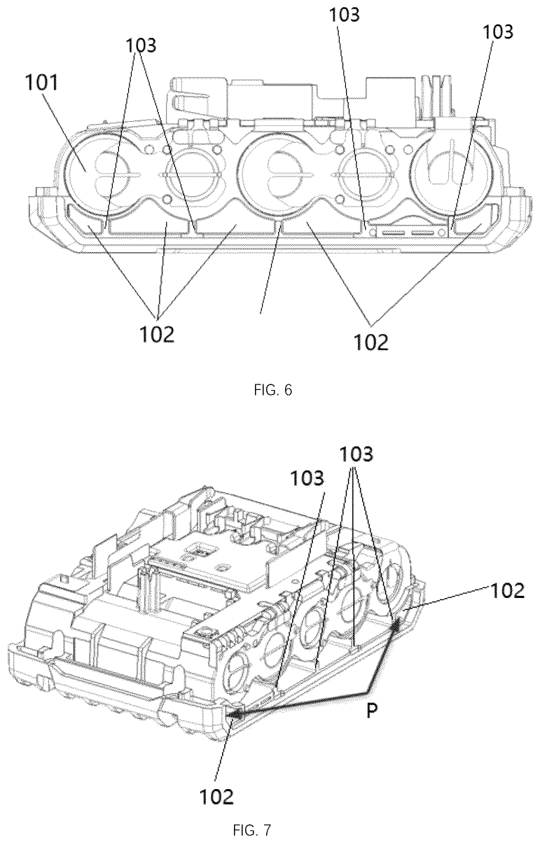

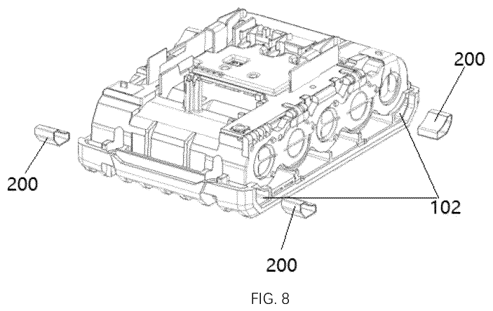

As shown in FIGS. 2 and 6, in some embodiments, and in some more specific embodiments, at least one cavity 102 may extend along the axial direction of the cell accommodating chamber 101, and the cavity 102 may be disposed below the cell accommodating chamber 101.

Of course, in other embodiments, the relative positions of the cavity and the cell accommodating chamber may also be changed as needed; e.g., the cavity may also be disposed above the cell accommodating chamber, on both sides in the axial direction of the cell accommodating chamber, or on both sides in the radial direction of the cell accommodating chamber.

In some embodiments, considering that the corners of the battery pack are more susceptible to impact, as shown in FIG. 7, at least one cavity 102 is disposed at a corner P of the battery pack housing.

In some more specific embodiments, a buffer element may be provided within at least one of the cavities in order to further enhance the vibration reduction effect. In particular, a buffer element may be provided within the cavity at a corner.

In some more specific embodiments, the buffer element may comprise an elastomeric filler filled within the cavity, such as a rubber block, airbag, or similar elastomeric element with a certain supporting force.

In still other more specific embodiments, the buffer element may also comprise a spring plate 200 built into the buffer cavity. The spring plate 200 may be annular.

Through the above structural design, the present disclosure simplifies the battery pack housing structure, facilitates its implementation, and effectively protects the battery cells, reducing deformation. It can be easily applied to a variety of battery packs.

The present disclosure further provides a battery pack in another embodiment. Since the present disclosure does not make any special improvements to the other structures of the battery pack, the detailed structure of the battery pack will not be described in detail here.

In one embodiment, the present disclosure further provides an electric tool with the battery pack described above, which has high safety and a good user experience. Since the present disclosure does not make any special improvements to the other structures of the electric tool, the detailed structure of the electric tool will not be described in detail here.

In some specific embodiments, the electric tool may be a rotary hammer, an electric drill, an angle grinder, a circular saw, or another electric tool that uses a battery pack.

It is to be noted that the prior art portion of the protective scope of the present disclosure is not limited to the embodiments given in the present disclosure. All prior art that does not contradict the solution of the present disclosure, including but not limited to prior patent documents, prior publications, prior public uses, etc., can be included in the protective scope of the present disclosure.

In addition, the combinations of the various technical features in the present case are not limited to the combinations recorded in the claims of the present case or the combinations recorded in the specific embodiments. All the technical features recorded in the present case may be freely combined or combined in any manner, unless there is a conflict between them.

It is also to be noted that the embodiments listed above are only specific embodiments of the present disclosure. Obviously, the present disclosure is not limited to the above embodiments. Any similar changes or modifications made thereto that can be directly derived or easily conceived by those skilled in the art from the content disclosed in the present disclosure should fall within the protective scope of the present disclosure.

What is claimed is:

1. A battery pack housing, comprising:
a housing structure;
a cell accommodating chamber arranged inside the housing structure;
at least one wall structure arranged between an outer wall of the cell accommodating chamber and the housing structure,
wherein the at least one wall structure, the housing structure, and the outer wall of the cell accommodating chamber are configured to form a number of closed cavities.

2. The battery pack housing according to claim 1, wherein:
the housing structure includes a first housing portion and a second housing portion arranged separately and connected together,
the cell accommodating chamber is disposed on the second housing portion, and
the first housing portion and the second housing portion are connected together with the wall structure and the outer wall of the cell accommodating chamber to form the closed cavities.

3. The battery pack housing according to claim 2, wherein the Young's modulus of the second housing portion is less than the Young's modulus of the first housing portion.

4. The battery pack housing according to claim 3, wherein the difference between the Young's modulus of the second housing portion and the Young's modulus of the first housing portion is 600-3500 MPa.

5. The battery pack housing according to claim 2, wherein:
an inner side of the first housing portion has a surface and is provided with a rib that protrudes from the surface,
the second housing portion is provided with a slot, and
an end of the rib is arranged correspondingly in the slot.

6. The battery pack housing according to claim 5, wherein the rib is disposed at an axial end face of the cell accommodating chamber.

7. The battery pack housing according to claim 1, wherein at least one of the closed cavities extends through at least one full-size direction of the housing structure.

8. The battery pack housing according to claim 1, wherein at least one closed cavity is disposed at a corner of the housing structure.

9. The battery pack housing according to claim 1, wherein at least one closed cavity extends along an axial direction of the cell accommodating chamber and is disposed below the cell accommodating chamber.

10. The battery pack housing according to claim 1, wherein at least one of the closed cavities is provided with a buffer element.

11. The battery pack housing according to claim 10, wherein the buffer element is disposed at least within a closed cavity at a corner of the housing structure.

12. The battery pack housing according to claim 10, wherein the buffer element includes an elastomeric filler and/or a spring plate.

13. A battery pack, comprising:
the battery pack housing according to claim 1; and
a battery cell arranged within the cell accommodating chamber of the battery pack housing.

14. An electric tool, comprising the battery pack housing according to claim 13.
